(19) United States
(12) Patent Application Publication
(10) Pub. No.: US 2024/0193902 A1
(43) Pub. Date: Jun. 13, 2024

(54) MEDICAL INFORMATION PROCESSING DEVICE, MEDICAL INFORMATION PROCESSING METHOD, AND STORAGE MEDIUM

(71) Applicant: CANON MEDICAL SYSTEMS CORPORATION, Otawara-shi (JP)

(72) Inventors: Asateru KIMURA, Otawara (JP); Sho SASAKI, Utsunomiya (JP); Kazumasa NORO, Shioya-gun (JP); Yuka MATSUMURA, Shioya-gun (JP)

(73) Assignee: CANON MEDICAL SYSTEMS CORPORATION, Otawara-shi (JP)

(21) Appl. No.: 18/531,782

(22) Filed: Dec. 7, 2023

(30) Foreign Application Priority Data
Dec. 12, 2022 (JP) 2022-197878

(51) Int. Cl. G06V 10/22; G06V 10/26; G06V 10/44; G06V 10/762; G06V 10/764

(52) U.S. Cl. CPC G06V 10/23; G06V 10/267; G06V 10/457; G06V 10/763; G06V 10/764; G06V 2201/03

(57) ABSTRACT

A medical information processing device of an embodiment includes processing circuitry. The processing circuitry acquires a medical image to be processed, divides the medical image into a plurality of regions, calculates an image feature amount for each of the plurality of regions, generates a first cluster in which at least some of the plurality of regions are collected on the basis of the image feature amount, and identifies a sampling position on the basis of the first cluster.

### CROSS-REFERENCE TO RELATED APPLICATION

The present application claims priority based on Japanese Patent Application No. 2022-197878 filed Dec. 12, 2022, the content of which is incorporated herein by reference.

### FIELD

Embodiments disclosed in this specification and the drawings relate to a medical information processing device, a medical information processing method, and a storage medium.

### BACKGROUND

When estimating genetic mutations, so-called multi-region sequencing in which sequencing is performed from a plurality of locations in the same tumor has been performed. Multi-region sequencing is performed, for example, for clinical applications and clinical research. Multi-region sequencing for clinical applications is used, for example, to confirm definitive diagnosis and tumor characteristics. Tumor characteristics include, for example, radioresistance and drug resistance. Multi-region sequencing for clinical research is used, for example, to create evolutionary trees for explaining tumor heterogeneity and evolutionary processes.

At the time of performing multi-region sequencing, it is difficult to determine which region needs to be sampled to reflect tumor characteristics due to the spatial heterogeneity of genetic mutations in tumors, and thus it is difficult to determine an appropriate sampling region. Therefore, increasing the number of samples may be conceived, but increasing the number of samples increases the cost incurred for sequencing and the burden on a patient.

There is a technique for classifying pathological characteristics of an observation area on the basis of pathological characteristics based on images of the surrounding area. With this technique, pathological characteristics of an observation area can be efficiently classified. However, with this technique, it is difficult to narrow down a sampling region (sampling position) because it is impossible to identify which region best reflects tumor characteristics among a plurality of regions representing the same tumor characteristics.

### BRIEF DESCRIPTION OF THE DRAWINGS

FIG. 1 is a block diagram showing an example of a configuration of an in-hospital system 1.

FIG. 2 is a block diagram showing an example of a configuration of a medical information processing device 100 of a first embodiment.

FIG. 3 is a flowchart showing an example of processing in the medical information processing device 100 of the first embodiment.

FIG. 4 is a diagram showing an example of transition of a medical image subjected to image processing performed by the medical information processing device 100.

FIG. 5 is a part of a flowchart showing an example of processing in the medical information processing device 100 of a second embodiment.

FIG. 6 is a diagram for describing a distance d between clusters.

FIG. 7 is a diagram showing an example of transition of a medical image subjected to image processing performed by the medical information processing device 100 of the second embodiment.

FIG. 8 is a diagram for describing a method of identifying a sampling position.

### DETAILED DESCRIPTION

Hereinafter, a medical information processing device, a medical information processing method, and a storage medium according to embodiments will be described with reference to the drawings. The medical information processing device of embodiments, for example, divides a tumor region in an image including a tumor, calculates an image feature amount for each divisional region, clusters the divisional regions on the basis of image feature amounts, and determines regions that are histologically similar or have similar tumor characteristics. The medical information processing device of the embodiments identifies an appropriate sampling position from among the clustered regions.

A medical information processing device of an embodiment includes processing circuitry. The processing circuitry acquires a medical image to be processed, divides the medical image into a plurality of regions, calculates an image feature amount for each of the plurality of regions, generates a first cluster in which at least some of the plurality of regions are collected on the basis of the image feature amount, and identifies a sampling position on the basis of the first cluster.

### First Embodiment

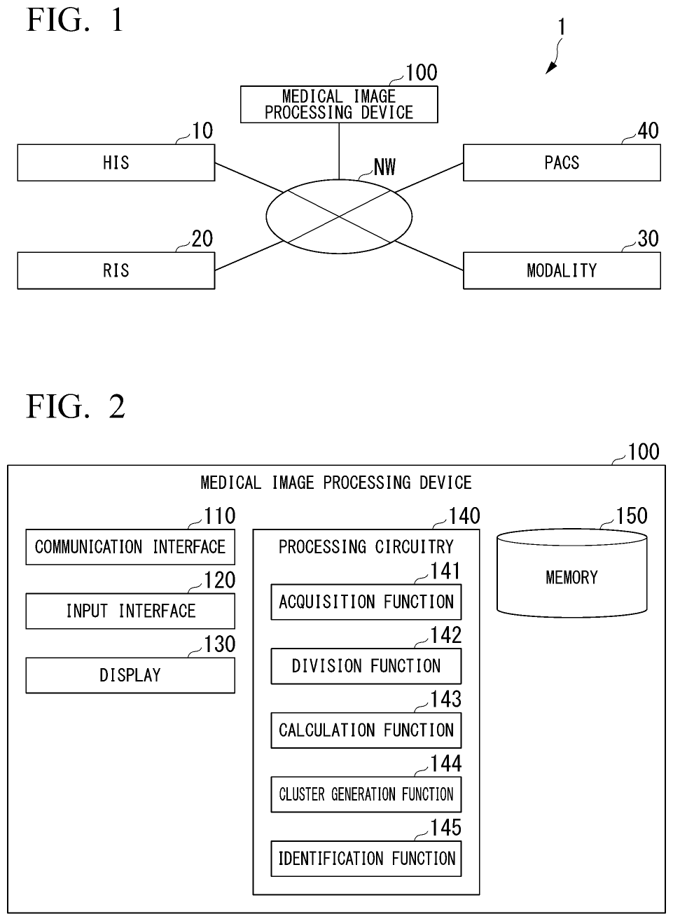

First, a first embodiment will be described. FIG. 1 is a block diagram showing an example of a configuration of an in-hospital system 1. The in-hospital system 1 of the first embodiment includes, for example, a hospital information system (hereinafter referred to as HIS) 10, a radiology information system (hereinafter referred to as RIS) 20, a medical image diagnostic device (modality) 30, a picture archiving and communication system (PACS) 40, and a medical information processing device 100.

The HIS 10 is a computer system that provides operational support within a hospital. Specifically, the HIS 10 has various subsystems. The various subsystems include, for example, an electronic medical record system, a medical accounting system, a medical reservation system, a hospital visit reception system, and an admission/discharge management system.

The HIS 10 includes, for example, a computer such as a server device or a client terminal including a processor such as a central processing unit (CPU), a memory such as a read only memory (ROM) or a random access memory (RAM), a display, an input interface, and a communication interface.

The RIS 20 is a computer system that provides operational support between image diagnosis departments. The RIS 20 performs association of reservation information with examination equipment, management of examination information, and the like in addition to reservation management of image examination orders in association with the HIS 10. The RIS 20 includes, for example, a computer such as a server device or a client terminal including a processor such as a CPU, a memory such as a ROM or a RAM, a display, an input interface, and a communication interface.

The modality 30 executes image-capturing (imaging) according to imaging conditions (imaging protocol) determined on the basis of an image examination instruction or the like, for example. Examples of the modality 30 include an X-ray computed tomography device, an X-ray diagnostic device, a magnetic resonance imaging device, an ultrasound diagnostic device, a nuclear medical diagnostic device, and the like. Medical images include, for example, radiographic images, magnetic resonance images, and ultrasound images. The modality 30 is operated by, for example, an operator such as a doctor (radiologist) or a medical radiology technician. Medical images (image data) generated by imaging by the modality 30 are transmitted to the PACS 40. Medical images include planar images and stereoscopic images (volume images).

The PACS 40 is a computer system that receives medical images transmitted by the modality 30 and stores them in a database. The PACS 40 transmits (transfers) medical images stored in the database in response to a request from a client. The PACS 40 includes a server computer including a processor such as a CPU, a memory such as a ROM or a RAM, a display, an input interface, and a communication interface.

The configuration of the in-hospital system 1 is not limited to the above. The in-hospital system 1 may include, for example, an image interpretation report creation device and the like. Moreover, some elements of the in-hospital system 1 may be integrated. For example, the HIS 10 and the RIS 20 may be integrated into one system.

The medical information processing device 100 acquires a medical image to be processed in medical images such as magnetic resonance images obtained by imaging a specimen used in multi-region sequencing, and identifies a position (hereinafter, a sampling position) suitable for sampling within the medical image. The medical information processing device 100 presents the identified sampling position to a user.

FIG. 2 is a block diagram showing an example of a configuration of the medical information processing device 100 of the first embodiment. The medical information processing device 100 includes, for example, a communication interface 110, an input interface 120, a display 130, processing circuitry 140, and a memory 150. Although the communication interface 110, the input interface 120, and the display 130 in the medical information processing device 100 are provided separately from the communication interface, the input interface, and the display included in the HIS 10, these may be common.

The communication interface 110 communicates with external devices such as the RIS 20, the modality 30, and the PACS 40 via a network NW such as a local area network (LAN). The communication interface 110 includes, for example, a communication interface such as a network interface card (NIC). The network NW may include the Internet, a cellular network, a Wi-Fi network, a wide area network (WAN), and the like instead of or in addition to a LAN.

The input interface 120 receives various input operations from a user such as a doctor, converts the received input operations into electrical signals, and outputs the electrical signals to the processing circuitry 140. For example, when a user performs an input operation, the input interface 120 generates information according to the input operation. The input interface 120 outputs the generated information corresponding to the input operation to the processing circuitry 140.

The input interface 120 includes, for example, a mouse, a keyboard, a trackball, a switch, a button, a joystick, a touch panel, and the like. The input interface 120 may be, for example, a user interface through which voice input is received, such as a microphone. In a case where the input interface 120 is a touch panel, the input interface 120 may also have the display function of the display 130.

Note that in this specification, the input interface is not limited to one that includes physical operation parts such as a mouse and a keyboard. For example, examples of the input interface also include electrical signal processing circuitry that receives an electrical signal corresponding to an input operation from external input equipment provided separately from the device and outputs this electrical signal to a control circuit.

The display 130 displays various types of information. For example, the display 130 displays images generated by the processing circuitry 140, a graphical user interface (GUI) for receiving various input operations from an operator, and the like. For example, the display 130 is a liquid crystal display (LCD), a cathode ray tube (CRT) display, an organic electroluminescence (EL) display, or the like.

The processing circuitry 140 includes, for example, an acquisition function 141, a division function 142, a calculation function 143, a cluster generation function 144, and an identification function 145. The processing circuitry 140 realizes these functions by, for example, a hardware processor (computer) executing a program stored in the memory (storage circuit) 150.

The hardware processor is, for example, circuitry such as a CPU, a graphics processing unit (GPU), an application specific integrated circuit (ASIC), a programmable logic device (for example, a simple programmable logic device (SPLD) or a complex programmable logic device (CPLD) and a field programmable gate array (FPGA).

Instead of storing the program in the memory 150, the program may be directly incorporated into the circuit of the hardware processor. In this case, the hardware processor realizes the functions by reading and executing the program incorporated into the circuit. The aforementioned program may be stored in advance in the memory 150 or stored in a non-transitory storage medium such as a DVD or a CD-ROM and installed in the memory 150 from the non-transitory storage medium when the non-transitory storage medium is set in a drive device (not shown) of the medical information processing device 100.

The hardware processor is not limited to being configured as a single circuit, but may be configured as one hardware processor by combining a plurality of independent circuits to realize each function. Further, a plurality of components may be integrated into one hardware processor to realize each function. Although the hardware processor, the memory, and the like in the medical information processing device 100 are provided separately from the hardware processor, the memory, and the like in the HIS 10, they may be common.

The acquisition function 141 transmits a request for a medical image to be processed to the PACS 40 using the communication interface 110. The PACS 40 transmits the medical image to the medical information processing device 100 in response to the request. The acquisition function 141 acquires the medical image transmitted by the PACS 40 and received by the communication interface 110. The acquisition function 141 is an example of an acquisition unit.

The division function 142 divides the medical image into a plurality of regions. The division function 142 divides the medical image into a grid (squares) having a predetermined shape and scale, for example. For example, a grid element may one-to-one correspond to a pixel, or a plurality of pixels may be included in a grid element.

In a case where the medical image is a planar image, the grid is, for example, a square. The grid may have a shape other than a square. The grid may have a shape surrounded by straight lines, such as a rectangle other than a square or a regular polygon, for example. In a case where the medical image is a stereoscopic image, the grid is, for example, a cube, but may be a rectangular parallelepiped other than a cube, or may have other shapes. The division function 142 is an example of a division unit. A grid element is an example of a region.

The calculation function 143 calculates an image feature amount for each of the plurality of regions. The image feature amount represents, for example, tumor heterogeneity. The image feature amount may be other than that representing tumor heterogeneity. The image feature amount may be, for example, various image feature amounts handled in radiogenomics (a science that systematically handles a large amount of information regarding genes). The calculation function 143 is an example of a calculation unit.

The cluster generation function 144 generates multi-layered clusters in which at least some of grid elements are collected on the basis of image feature amounts. A cluster includes a plurality of (two or more) regions. The number of layers of clusters (hereinafter, a specified number of clusters) generated by the cluster generation function 144 can be determined in advance. For example, in a case where the specified number of clusters is 2, the cluster generation function 144 generates a first layer cluster and a second layer cluster. The specified number of clusters may be, for example, the value of k in the k-means method.

The cluster generation function 144 generates clusters according to predetermined conditions. The cluster generation function 144 classifies grid elements into a first-layer cluster grid element and a second-layer cluster grid element on the basis of, for example, the magnitude of image feature amounts. For example, the cluster generation function 144 calculates an image feature amounts in each grid element in which a tumor is included in a medical image. The cluster generation function 144 is an example of a cluster generation unit.

The cluster generation function 144 classifies grid elements including a tumor in a medical image. The cluster generation function 144 classifies the grid elements depending on the specified number of clusters. Since the specified number of clusters is 2, the cluster generation function 144 classifies the grid elements into a grid element (hereinafter, a first layer cluster grid element) having a small (low) image feature amount (tumor heterogeneity) and a grid element (hereinafter, a second layer cluster grid element) having a large (high) image feature amount. The cluster generation function 144 connects adjacent first layer cluster grid elements to generate a first layer cluster, and connects adjacent second layer cluster grid elements to generate a second layer cluster.

In determining whether or not grid elements are connected, the cluster generation function 144 may determine that the grid elements are connected, for example, when two grid elements are in line contact in a case where a medical image is a planar image. The cluster generation function 144 may determine that two grid elements are connected when they are in point contact or line contact.

In a case where it is determined that grid elements are connected when the two grid elements are in line contact, grid elements on the four sides of a square grid element are connected. In a case where it is determined that grid elements are connected when they are in point or line contact, grid elements on eight sides of the grid are connected.

If the medical image is a stereoscopic image, the cluster generation function 144 may determine that grid elements are connected when the two grids are in surface contact, for example. The cluster generation function 144 may determine that two grid elements are connected when they are in surface contact or line contact. The cluster generation function 144 may determine that two grid elements are connected when they are in surface contact, line contact, or point contact.

In a case where it is determined that grid elements are connected when the two grid elements are in surface contact, grid elements on six sides of a cubic grid are connected. In a case where it is determined that grid elements are connected when the two grid elements are in surface contact or line contact, grid elements on 18 sides of a grid are connected. In a case where it is determined that grid elements are connected when the two grid elements are in surface contact, line contact or point contact, grid elements on 26 sides of a grid are connected.

The cluster generation function 144 generates one or more first layer clusters and second layer clusters. The first layer cluster and the second layer cluster are formed by interconnected grid elements. Therefore, for example, if a plurality of first layer cluster grid elements are located apart from each other, these first layer cluster grid elements are included in different first layer clusters. Therefore, a plurality of first layer clusters may be generated. In a case where the cluster generation function 144 generates a plurality of first layer clusters, one of the first layer clusters is an example of a first cluster, and another one of the first layer clusters is an example of a second layer cluster related to the first cluster.

The identification function 145 identifies a first sampling position (hereinafter, a first sampling position) on the basis of the first layer cluster generated by the cluster generation function 144. The identification function 145 identifies a second sampling position (hereinafter, a second sampling position) on the basis of the second layer cluster generated by the cluster generation function 144. The identification function 145 is an example of an identification unit.

In identifying the first sampling position, in a case where there are a plurality of first layer cluster, the identification function 145 counts the number of connections of the plurality of first layer clusters. The identification function 145 identifies the first sampling position on the basis of the result of the counted number of connections. The identification function 145 identifies the first sampling position on the basis of a first layer cluster having the largest number of connections. For example, when there are two first layer clusters, the identification function 145 identifies one of the clusters that has a large number of connections, and identifies a sampling position within the cluster having a large number of connections. The identification function 145 identifies the second sampling position using the same procedure.

The identification function 145 outputs the calculated sampling position. The identification function 145 outputs the sampling position by causing the display 130 to display the sampling position, for example. The identification function 145 may output the sampling position in other manners. The identification function 145 may output the sampling position, for example, to an external device such as a tablet terminal used by the user, for example, using the communication interface 110.

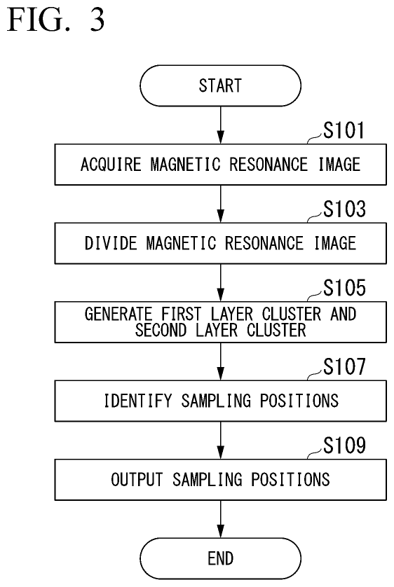

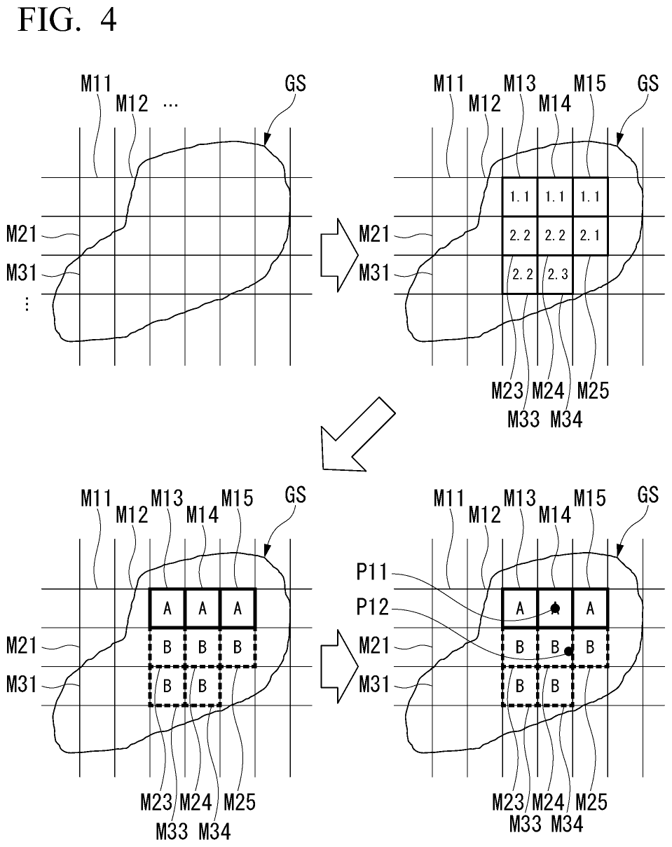

Next, processing in the medical information processing device 100 and transition of a medical image subjected to image processing performed by the medical information processing device 100 will be described. A case in which one first layer cluster and one second layer cluster are generated will be described. FIG. 3 is a flowchart showing an example of processing in the medical information processing device 100 of the first embodiment. FIG. 4 is a diagram showing an example of transition of a medical image subjected to image processing performed by the medical information processing device 100.

In the flow shown in FIG. 3, first, the medical information processing device 100 sends a request for a medical image to be processed to, for example, the PACS 40 through the acquisition function 141. The acquisition function 141 acquires the medical image transmitted by the PACS 40 and received by the communication interface 110 (step S101).

Subsequently, the division function 142 divides the medical image acquired by the acquisition function 141 into a plurality of grid elements constituting a grid (step S103). As shown in the upper left diagram of FIG. 4, the division function 142 divides ten resonance images including an affected area image GS into grid elements Mxy (x=1, 2, . . . , y=1, 2, . . . ). The grid elements Mxy have a predetermined shape and scale, and are elements having the same shape and scale.

Subsequently, the calculation function 143 calculates an image feature amount for each of grid elements Mxy including the affected area image GS among the grid elements Mxy. Although all grid elements for which image feature amounts are calculated are grid elements corresponding to the affected area image GS in the first embodiment, some grid elements corresponding to the affected area image GS and the other grid elements corresponding to an image other than the affected area image GS may be symmetrical.

The calculation function 143 calculates heterogeneity as an image feature amount of a grid element Mxy. The upper right diagram of FIG. 4 shows image feature amounts of grid elements M13, M14, M15, M23, M24, M25, M33, and M34. The image feature amounts of the grid elements M13, M14, and M15 are “1.1,” the image feature amounts of the grid elements M23, M24, and M33 are “2.2,” the image feature amount of the grid element M25 is “2.1,” and the image feature amount of the grid element M34 is “2.3.”

Subsequently, the cluster generation function 144 generates a first layer cluster and a second layer cluster on the basis of the calculated image feature amount of each grid element (step S105). For example, in a case where the specified number of clusters is set to 2, the cluster generation function 144 classifies the grid elements M13, M14, M15, M23, M24, M25, M33, and M34 into a first layer cluster grid element and a second layer cluster grid element and clusters them into the first layer cluster and the second layer cluster, as shown in the lower right diagram of FIG. 4.

The cluster generation function 144 classifies the grid elements M13, M14, and M15 as the first layer cluster grid elements and classifies the grid elements M23, M24, M25, M33, and M34 as the second layer cluster grid elements. The cluster generation function 144 generates the first layer cluster using the grid elements M13, M14, and M15 which are first layer cluster grid elements, and generates the second layer cluster using the grid elements M23, M24, M25, M33, and M34 which are second layer cluster grid elements.

Subsequently, the identification function 145 identifies a first sampling position and a second sampling position in the first layer cluster and the second layer cluster (step S107). As shown in the lower right diagram of FIG. 4, the identification function 145 identifies the center of gravity of all the grid elements (grid elements M13, M14, and M15) included in the first layer cluster as the first sampling position P11. The identification function 145 identifies the center of gravity of all grid elements (M23, M24, M25, M33, and M34) included in the second layer cluster as the second sampling position P12.

For example, at the time of identifying the first sampling position P11 of the first layer cluster, the identification function 145 may identify a position other than the center of gravity of all the first layer cluster grid elements included in the first layer cluster as the first sampling position. For example, the identification function 145 may set the center of gravity of some of the first layer cluster grid elements selected according to predetermined conditions as the first sampling position P11, or may set a point where the sum of distances from the edge of the first layer cluster is the smallest as the first sampling position P11.

In a case where a plurality of first layer clusters are generated by the cluster generation function 144 in step S105, the identification function 145 identifies a sampling position on the basis of the number of connected grid elements included in each first layer cluster in identifying a sampling position. The plurality of first layer clusters generated here are clusters that have common image feature amounts.

For example, the identification function 145 selects a first layer cluster with the largest number of connections from among the plurality of first layer clusters. The identification function 145 identifies a sampling position within the selected first layer cluster. The identification function 145 identifies, for example, the center of gravity of the selected first layer cluster as the first sampling position P11.

Subsequently, the identification function 145 outputs the identified first sampling position P11 and second sampling position P12 by causing the display 130 to display them (step S109). Alternatively, the identification function 145 outputs the first sampling position P11 and the second sampling position by transmitting them to an external device using the communication interface 110. In this manner, the medical information processing device 100 ends processing shown in FIG. 3.

The medical information processing device 100 of the first embodiment divides a tumor region in a medical image including a tumor, and calculates an image feature amount for each divisional region. The medical information processing device 100 determines regions that are histologically similar or have similar tumor characteristics by clustering the divisional regions on the basis of image feature amounts. Therefore, it is possible to identify an appropriate sampling position in multi-region sequencing in a clustered region.

### Second Embodiment

Next, a second embodiment will be described. A medical information processing device 100 of the second embodiment differs from the medical information processing device 100 of the first embodiment mainly with respect to processing in the cluster generation function 144. In the medical information processing device 100 of the second embodiment, at the time of generating clusters with layers corresponding to a specified number of clusters, a plurality of clusters are unified in a case in which a maximum connected component in each cluster is less than a threshold value or a case in which characteristics of clusters with different layers are similar (approximate). The medical information processing device 100 of the second embodiment will be described below, focusing on differences from the first embodiment.

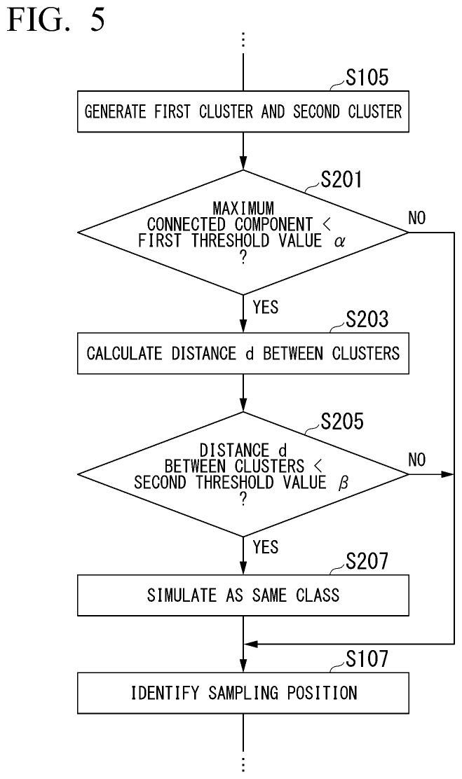

Next, processing in the medical information processing device 100 of the second embodiment will be described. FIG. 5 is a part of a flowchart showing an example of processing in the medical information processing device 100 of the second embodiment. The medical information processing device 100 of the second embodiment performs the same processing as steps S101 to S105 of the medical information processing device 100 of the first embodiment shown in FIG. 3.

Subsequently, the medical information processing device 100 of the second embodiment determines whether a maximum number of grid elements included in each of the plurality of first layer clusters (hereinafter, a maximum connected component) is less than a first threshold value α through the cluster generation function 144 (step S201). In a case where it is determined that the maximum connected component is not less than the first threshold value α (is equal to or greater than the first threshold value a), the cluster generation function 144 causes processing to proceed to step S107.

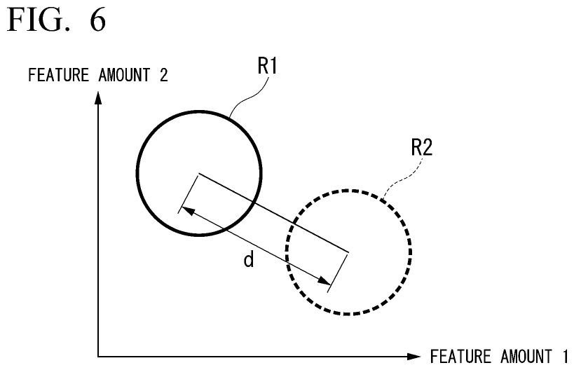

In a case where the cluster generation function 144 determines that the maximum connected component is not less than the first threshold value α (is equal to or greater than the first threshold value α), the cluster generation function 144 calculates a distance d between the first layer cluster and the second layer cluster (between clusters) (step S203). FIG. 6 is a diagram for describing the distance d between clusters.

For example, the cluster generation function 144 generates clusters on the basis of feature amount 1 and feature amount 2 and obtains, as the distance d between the clusters, a distance between the center of a region R1 indicating a set of first layer cluster grid elements included in the first layer cluster and the center of a region R2 indicating a set of second layer cluster grid elements included in the second layer cluster. The cluster generation function 144 determines whether the distance d between the clusters is less than a second threshold value β (step S205).

In a case where it is determined that the distance d between the clusters is not less than the second threshold value β, the cluster generation function 144 determines that the first layer cluster and the second layer cluster are not similar, and causes processing to proceed to step S107. In a case where it is determined that the distance d between the clusters is not less than the second threshold value β (is equal to or greater than the second threshold value β), the cluster generation function 144 determines that the first layer cluster and the second layer cluster are not similar and causes processing to proceed to step S107.

In a case where the cluster generation function 144 determines that the distance d between the clusters is less than the second threshold value, the cluster generation function 144 determines that the first layer cluster and the second layer cluster are similar and simulates the first layer cluster and the second layer cluster as the same class (step S207). The cluster generation function 144 sets the first layer cluster including second layer clusters in the same class. In the following step S107, a sampling position is identified from the cluster in step S207.

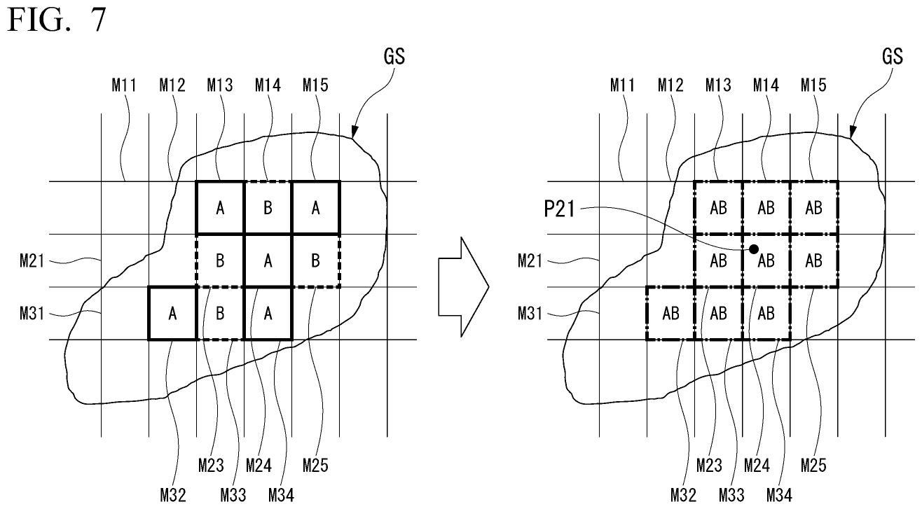

FIG. 7 is a diagram showing an example of transition of a medical image subjected to image processing performed by the medical information processing device 100 of the second embodiment. In the example shown in FIG. 7, grid elements M13, M15, M24, M32, and M34 are first layer cluster grid elements, and grid elements M14, M23, M25, and M33 are second layer cluster grid elements. In FIG. 7, the first layer cluster grid elements are labeled “A” and the second layer cluster grid elements are labeled “B.”

In a case where the distance d between the first layer cluster and the second layer cluster exceeds the second threshold value β, the first layer cluster and the second layer cluster are unified. Therefore, the grid elements M13, M14, M15, M23, M24, M25, M32, M33, and M34 become a first and second layer unified cluster. In FIG. 7, the grid elements included in the first and second layer unified cluster are labeled “AB.” The identification function 145 identifies, for example, the center of gravity of the grid elements M13, M14, M15, M23, M24, M25, M32, M33, and M34 as a sampling position P21.

The medical information processing device 100 of the second embodiment has the same effects as the medical information processing device 100 of the first embodiment. Furthermore, in a case where the maximum connected component in each cluster is less than the first threshold value and the distance d between clusters with different layers is less than the second threshold value, the medical information processing device 100 of the second embodiment unifies clusters with different layers. Therefore, it is possible to prevent a cluster area from being excessively narrowed, and it is also possible to widen an area for identifying a sampling position within an approximate range. Regardless of whether the maximum connected component in each cluster is less than the first threshold value, clusters with different layers may be unified in a case where the distance between the clusters with different layers is less than the second threshold value.

### Third Embodiment

Next, a third embodiment will be described. A medical information processing device 100 of the third embodiment identifies a biopsy region in needle biopsy. For example, at the time of performing a needle biopsy on a patient with a tumor, it may be desirable to perform the needle biopsy at fewer locations, for example, three locations in consideration of the burden on the patient. In such a case, the medical information processing device 100 of the third embodiment sets a specified number of clusters as the number of locations where a needle biopsy will be performed and identifies sampling positions. For example, the medical information processing device 100 generates and outputs a tumor characteristic prediction map to which identified sampling positions are attached. Other points are similar to the medical information processing device 100 of the first embodiment. The tumor characteristic prediction map is stored, for example, in a tablet terminal used by a user. For example, the medical information processing device 100 outputs the tumor characteristic prediction map by transmitting the sampling positions to a tablet terminal that stores the tumor characteristic prediction map.

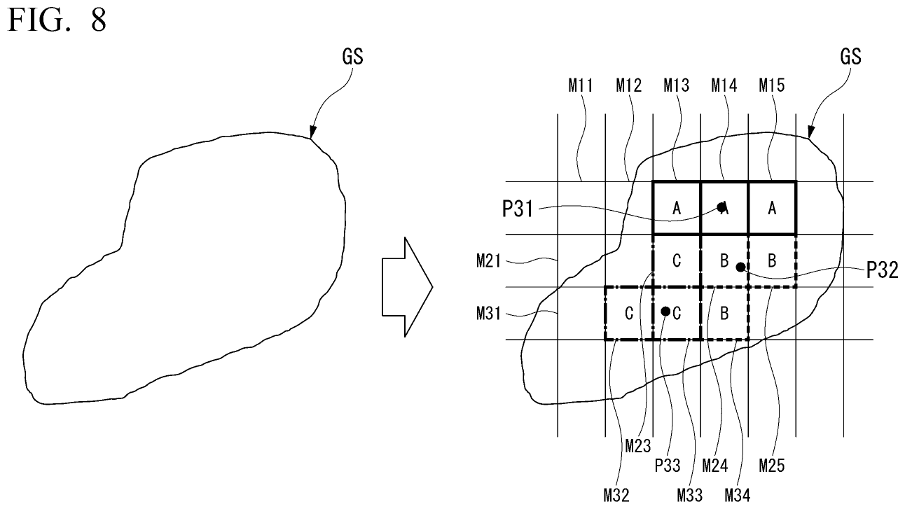

FIG. 8 is a diagram for describing a method of identifying a sampling position. In the medical information processing device 100 of the third embodiment, for example, the division function 142 sets grid elements as shown in the right diagram of FIG. 8 for a medical image including an affected area image GS shown in the left diagram of FIG. 8. Subsequently, after the calculation function 143 calculates an image feature amount for each grid element, the cluster generation function 144 generates three-layered clusters with the specified number of clusters being three.

In the right diagram of FIG. 8, grid elements M13 and M15 are first layer cluster grid elements, grid elements M24, M25, and M34 are second layer cluster grid elements, and grid elements M23, M32, and M33 are third layer cluster grid elements. In FIG. 8, the first layer cluster grid elements are labeled “A,” the second layer cluster grid elements are labeled “B,” and the third layer cluster grid elements are labeled “C.”

The identification function 145 identifies a first sampling position P31, a second sampling position P32, and a third sampling position P33 for the first layer cluster, the second layer cluster, and the third layer cluster, respectively. The identification function 145 transmits the identified first sampling position P31, second sampling position P32, and third sampling position P33 to, for example, a tablet terminal in which the tumor characteristic prediction map is stored.

The tablet terminal that has received the first sampling position P31, second sampling position P32, and third sampling position P33 writes each of the sampling positions in the tumor characteristic prediction map. In this manner, the tumor characteristic prediction map is improved in the tablet terminal, and the user can easily recognize sampling positions.

The tumor characteristic prediction map may be stored in the medical information processing device 100 in addition to being stored in an external device. In this case, the processing circuitry 140 in the medical information processing device 100 has a writing function for writing sampling positions identified by the identification function 145 into the tumor characteristic prediction map and writes the first sampling position P31, the second sampling position P32, and the third sampling position P33 into the tumor characteristic sampling map.

The medical information processing device 100 of the third embodiment has the same effects as the medical information processing device 100 of the first embodiment. The medical information processing device 100 of the third embodiment refers to the tumor characteristic prediction map in which sampling positions are identified. Accordingly, a tumor prediction map in which needle biopsy sampling positions are added to a user is generated. Therefore, a highly useful tumor prediction map can be easily produced.

In the medical information processing device 100 of each embodiment described above, in a case where a plurality of clusters of the same layer are generated, a sampling position is identified in the cluster with the largest number of connections, but a sampling position may be identified in a cluster other than the cluster with the largest number of connections. In this case, a plurality of sampling positions are identified for clusters of one layer, and these plurality of sampling positions may be prioritized. For example, superiority or inferiority may be determined depending on the number of connections of each cluster, and for example, the higher the number of connections, the higher the priority. For example, in a case in which it is difficult to perform a biopsy at the sampling position with the highest priority, when a puncture needle reaches the sampling position, for example, a biopsy may be performed using the next high priority sampling position in a case where the puncture needle passes through a major organ, for example, the heart.

Further, the medical information processing device 100 may output information other than a sampling position, for example, information on a spatial region until the puncture needle reaches the sampling position. In this case, a region that passes through a sampling position identified by the identification function 145 and does not pass through cluster grid elements of other layers may be displayed. Since the puncture needle does not pass through cluster grid elements of other layers, specimens can be collected without passing through cluster grid elements of other layers.

In the medical information processing device 100 of each embodiment described above, sampling positions are identified by setting different layers for grid elements with common characteristics, but sampling positions may be identified simultaneously for grid elements with different characteristics. For example, mammotome, needle biopsy, cytodiagnosis, and the like are used for sampling, and sampling positions for these may be identified simultaneously.

In this case, a doctor can check a specified number of sampling regions that reflect differences in histological and main characteristics. Therefore, an appropriate sampling position can be determined at the time of biopsy. Bioinformaticians can also analyze tumor heterogeneity and create evolutionary trees at low cost.

According to at least one embodiment described above, it is possible to perform appropriate sampling in multi-region sequencing by including an acquisition unit that acquires a medical image to be processed, a division unit that divides the medical image into a plurality of regions, a calculation unit that calculates an image feature amount for each of the plurality of regions, a cluster generation unit that generates a first cluster in which at least some of the plurality of regions are collected on the basis of the image feature amount, and an identification unit that identifies a sampling position on the basis of the first cluster.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical information processing device comprising processing circuitry, the processing circuitry being configured to:
acquire a medical image to be processed;
divide the medical image into a plurality of regions;
calculate an image feature amount for each of the plurality of regions;
generate a first cluster in which at least some of the plurality of regions are collected on the basis of the image feature amount; and
identify a sampling position on the basis of the first cluster.

2. The medical information processing device according to claim 1, wherein the processing circuitry is configured to:
generate a second cluster related to the first cluster; and
identify the sampling position on the basis of the number of connections of regions included in the first cluster and the second cluster.

3. The medical information processing device according to claim 2, wherein the processing circuitry is configured to:
identify one of the first cluster and the second cluster which has a larger number of connections; and
identify the sampling position within the identified one of the first cluster and the second cluster having the larger number of connections.

4. The medical information processing device according to claim 2, wherein the second cluster is a cluster having the image feature amounts common to the first cluster and is separated from the first cluster.

5. The medical information processing device according to claim 2, wherein
the medical image is a planar image, and
the processing circuitry is configured to:
divide the medical image into the regions in a rectangular shape; and
count the number of connections on the basis of the number of regions in contact each other in either line contact or point contact.

6. The medical information processing device according to claim 1, wherein
the medical image is a stereoscopic image, and
the processing circuitry is configured to divide the medical image into the regions in a rectangular parallelepiped shape.

7. The medical information processing device according to claim 2, wherein
the medical image is a stereoscopic image, and
the processing circuitry is configured to:
divide the medical image into the regions in a rectangular parallelepiped shape; and
count the number of connections on the basis of the number of regions in surface contact, line contact, or point contact with each other.

8. The medical information processing device according to claim 1, wherein the processing circuitry is configured to identify the sampling position on the basis of a point that is the center of gravity of the regions or a point at which the sum of distances from an edge of the regions is shortest within the regions.

9. A medical information processing method, using a computer, comprising:
acquiring a medical image to be processed;
dividing the medical image into a plurality of regions;
calculating an image feature amount for each of the plurality of regions;
generating a first cluster including at least some of the plurality of regions on the basis of the image feature amount; and
identifying a sampling position on the basis of the first cluster.

10. A computer-readable non-transitory storage medium storing a program for causing a computer to:
acquire a medical image to be processed;
divide the medical image into a plurality of regions;
calculate an image feature amount for each of the plurality of regions;
generate a first cluster including at least some of the plurality of regions on the basis of the image feature amount; and
identify a sampling position on the basis of the first cluster.
